(19) United States
(12) Patent Application Publication
(10) Pub. No.: US 2011/0309015 A1
(43) Pub. Date: Dec. 22, 2011

(54) Clarifier support structure

(75) Inventors: Gary Pashaian, Monroe, MI (US); Adam Pashaian, Monroe, MI (US)

(73) Assignee: Monroe Environmental Corporation, Monroe, MI (US)

(21) Appl. No.: 13/134,624

(22) Filed: Jun. 10, 2011

Related U.S. Application Data
(60) Provisional application No. 61/398,141, filed on Jun. 21, 2010.

(51) Int. Cl. B01D 17/00; B23P 17/04

(52) U.S. Cl. 210/513; 29/428

(57) ABSTRACT

A clarifier support structure for supporting tube or plate modules in a clarifier tank or basin is disclosed together with a method for installing the structure in a tank or basin. The structure comprises a first laterally extending truss supported on first and second opposed walls of the tank, a longitudinally extending truss supported at one end on the laterally extending truss and at a second end on a transversely extending wall of the tank, a first module support member supported at its ends on the first opposed side wall and on said longitudinally extending truss, and a second module support member supported at its ends on the second opposed side wall and on said longitudinally extending truss.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

1. Field of the Invention

This invention is in the field of large scale clarification systems for settling solids out of continuously flowing water or other liquid. Such systems are frequently employed in municipal and industrial water treatment systems.

2. Description of the State of the Art

Municipal and industrial water treatment clarification systems generally comprise some type of settling tank or basin with a gravity sedimentation system for removing solids from water or other liquid. Such tanks are, generally speaking, either circular or rectangular. This invention is particularly concerned with generally rectangular settling tanks although many features of the invention translate nicely into clarifiers involving circular tanks. Such tanks are typically built above ground or partially above ground. The settling tanks have a floor or bottom, an inlet and an outlet and they are generally open on top. Rectangular tanks also include a front wall, a rear wall and side walls. Typically, these tanks are made of concrete or steel.

During the operation of a clarification system, a liquid enters the settling tank through an inlet near the front wall and is directed generally horizontally in a longitudinal direction towards an outlet near the rear wall of the tank. The efficiency of a clarification system is greatly enhanced when an array of tube or plate modules (“modules”) is provided in a settling tank. These modules comprise a series of tubes or plates or the like and they are typically located near the outlet of the tank, preferably above and spaced from the tank floor. Liquid flowing through a settling tank provided with an array of modules is directed generally upwardly through the array of modules towards an outlet. In these types of clarification systems, the array of modules is supported in the settling tank by a clarifier support structure.

The modules increase the efficiency of clarifiers so that flow through rates can be increased substantially with improved effluent quality. The modules enhance the rate at which suspended solids are separated by gravity from the liquid in which they are suspended. The modules contribute to enhanced gravity separation in several ways. Unstable liquid flow patterns and mixing currents inhibit particle settlement rates. These undesirable flow patterns and mixing currents are drastically reduced through the use of modules. All together, the liquid contacting surfaces of the modules provide settling surfaces with a very large total surface area. The settling surfaces in the modules are inclined rather steeply and this reduces the distance that particles have to fall before contacting a settling surface. Once the super fine suspended particles come into contact with a settling surface, the particles begin to agglomerate into larger particles which settle much more rapidly than the fine particles. The enhanced gravity separation that is achieved with modules translates into relatively smaller settling tanks in new units. In existing units, increased flow through rate together with improved effluent quality are realized.

Liquid flowing upwardly through an array of modules moves very slowly and the liquid is clarified as gravity causes suspended solids to fall or settle towards the floor of the settling tank. The rate of movement of liquid through the modules is very slow, something on the order of three feet per minute or less. Clarified liquid then leaves the settling tank through an outlet which could be comprised of weirs or launders or the like.

A structure for supporting an array of modules in the upper rear portion of a settling tank should not be supported by or from the settling tank floor. The floor of the settling tank should not be obstructed by the clarifier support structure because sludge collects on the tank floor and the presence of clarifier support structure on or even near the tank floor would interfere with the collection of sludge. Sludge removal systems are provided at the bottom of settling tanks and the clarifier support structure must be designed so that it does not interfere with the sludge removal system.

In a clarifier support structure for supporting modules in a tank or basin, at least a portion of the support structure will be below the modules and the modules will be supported by that portion. However, the height and size of the support structure should be minimized in order to maximize the unimpeded flow of liquid up and into and through the modules and further, in some cases, in order to provide for the unimpeded operation of sludge removal apparatus below the modules.

U.S. Pat. No. 5,217,614 discloses a clarifier support structure which comprises an inverted T-shaped truss that is supported within the tank by wall engaging pads or pedestals. The design of the structure disclosed in this patent does a good job of minimizing the presence of elements of the structure that are below the modules. There are some penalties associated with this design, however, in terms of the level of difficulty associated with the installation of the modules. The structure also presents some difficulties attendant to the removal and replacement of individual modules. There are further problems that can arise from portions of the clarifier support structure breaching portions of the modules.

The present invention has many objects including, but by no means limited to, providing a clarifier support structure that (1) is easy to install in a settling tank, (2) when installed, has only minimal structure that is actually below the individual modules, (3) will not interfere with the collection and removal of sludge from the floor of the settling tank, (4) permits the easy and efficient removal and replacement of individual modules, (5) accommodates and compensates for variations in the width of the tanks and the shortest distance between the two side walls from any given point on one of the side walls, (6) minimizes the problem of liquid flowing around rather than through the modules, and (7) eliminates or minimizes module bypass arising from support structure actually extending into portions of the modules.

These and other objects and advantages of the present invention shall be apparent from the following detailed description with reference, therein, to the several drawing figures.

### BRIEF DESCRIPTION OF THE SEVERAL VIEWS OF THE DRAWING

FIG. 1 is a plan view of a settling tank in which there is mounted a clarifier support structure according to the invention;

FIG. 2 is cross sectional view of the settling tank shown in FIG. 1, taken along the line 2-2 of FIG. 1.

FIG. 3 is cross sectional view of the settling tank shown in FIG. 1, taken along the line 3-3 of FIG. 1.

FIG. 4 is a detail view of a truss and a truss wall support in a clarifier support structure according to the invention.

FIG. 5 is a detail view of a connection between a transverse truss and longitudinal truss in a clarifier support structure according to the invention.

FIG. 6 is a view, partially in cross section, showing clarifier support members and hangers for supporting the members from a longitudinal truss in the clarifier support structure.

FIG. 7 is a detail view of a clarifier support member and a clarifier support member wall support in a clarifier support structure according to the invention.

### DETAILED DESCRIPTION OF THE INVENTION

A clarifier support structure indicated generally at 10 is supported within a settling tank 12 in an upper, rear portion thereof. The tank 12 comprises a front wall 14, a rear wall 16, side walls 18 and a floor or bottom 20. The settling tank 12 is generally open at the top. The clarifier support structure 10 is well suited for use in a newly constructed settling tank and it is also well suited for use in replacing a clarifier support structure in an existing settling tank.

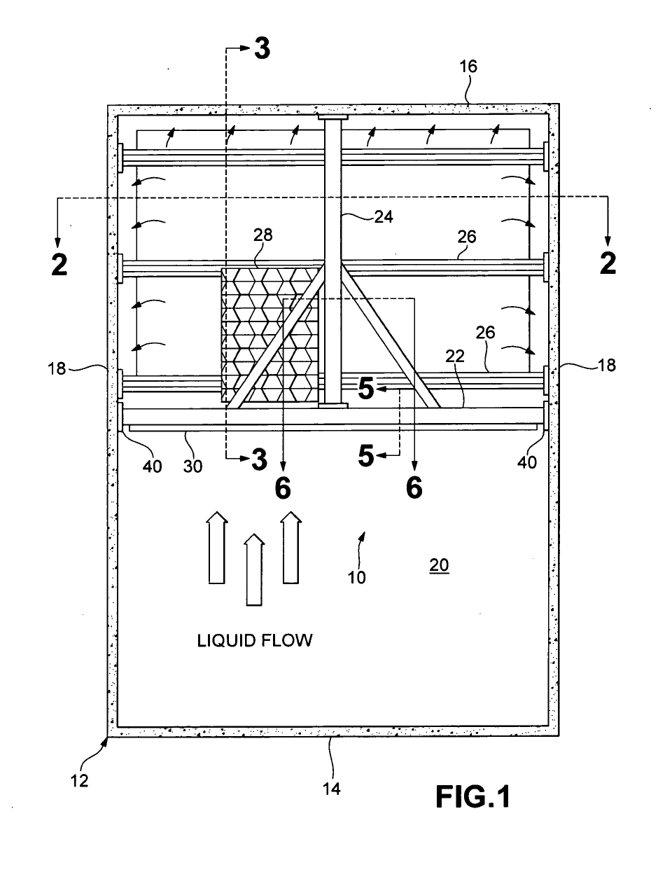

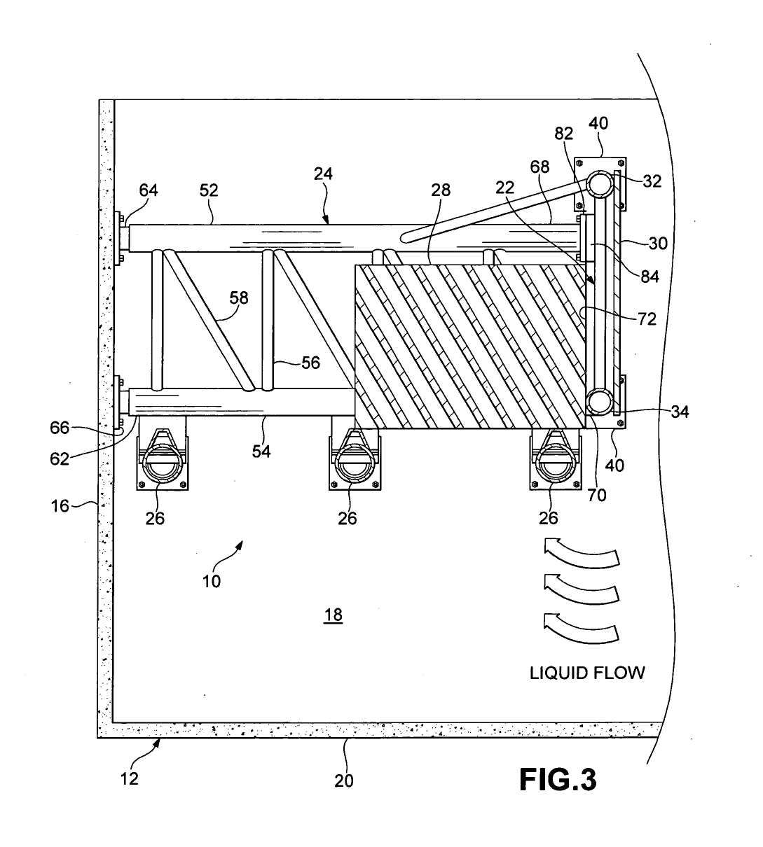

The clarifier support structure 10 comprises a laterally extending or lateral truss 22 which is supported, at its ends, on the side walls 18. The lateral truss, in turn, supports one end of a longitudinally extending or longitudinal truss 24. Longitudinal and lateral refer, here, to the direction of flow of liquid in the settling tank 12 which is indicated by arrows in FIGS. 1 and 3 and is, generally, towards the rear wall 16 from the front wall 14. The other end of the longitudinal truss is supported on the rear wall 16.

A plurality of module support members 26 is provided and they extend laterally within the tank 12, substantially parallel to the truss 22. The support members 26 are supported at one end on the longitudinal truss 24 and, at the other end, on one of the side walls 18. Thus, the support members 26 only extend one half of the lateral distance between the side walls 18, thereby drastically reducing the required size and minimum load-bearing capacity of these members 26. It will be appreciated that, in especially large settling tanks, i.e., tanks having a very long lateral dimension, a second or even a third longitudinal truss can be provided in order to further reduce the required size and minimum load-bearing capacity of the module support members 26.

A plurality of tube or plate modules 28 are supported on the module support members 26. For illustrative purposes only, a single representative module 28 is shown in FIGS. 1, 2 and 3. Of course, the number of module in a given installation will vary, based upon a consideration of many factors as known by persons of skill in the art. It is important to note, however, that the design of the clarifier support structure is especially suited to maximize the flow of liquid through the modules 28. As shown in FIG. 1, the module 28 that is adjacent to the longitudinal truss 24 (one truss 24 is shown in FIG. 1) snug right up to the truss 24, thereby preventing liquid from flowing upwardly between the module 28 and the longitudinal truss 24. Similarly, the module 28 which is adjacent to the lateral truss 22 snug right up to the truss 22, thereby preventing liquid from leaking, i.e., flowing upwardly between the module 28 and the trusses 22 and 24.

A baffle 30 is supported on the main, major, transverse truss 22. It serves to direct the flow of liquid entering the front of the tank 12 downwardly in order to maximize the flow of liquid into the lower rear portion of the tank 12, thereby maximizing the flow of liquid upwardly through the modules 28 in the upper rear section of the tank 12, in indicated by arrows in FIG. 3.

Turning now to the details of the structure which supports the module support members 26, it will be seen at once that it is remarkable in its engineering elegance. The lynch pin of the support structure is the transverse truss 22. In the embodiment shown in the drawing figures, the truss 22 is a simple truss with an upper chord 32 and a lower chord 34. Vertical struts 36 and diagonal struts 38 connect the chords 32 and 34 in a known manner. Of course, other trusses, both known and hereafter developed, may be utilized but there is a preference for trusses with a single upper chord and a single lower chord.

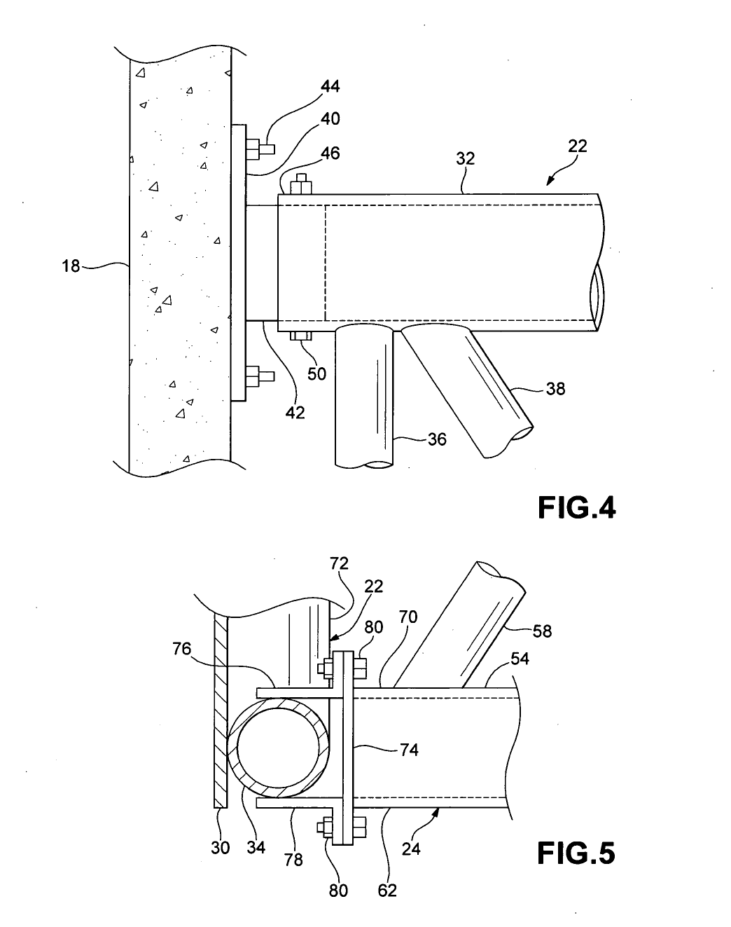

The truss 22 spans the width of the settling tank 12 between the side walls 18. In large settling tanks, however, with older concrete side walls, the walls will not be exactly parallel and the shortest distance between them, from any given point on one side wall, can vary significantly and must be accommodated. For this purpose, a wall support comprising a face plate 40 (FIG. 4) and a chord support 42 is provided. The chord support 42 is welded or otherwise connected to the face plate 40 which, in turn, is connected to the side wall 18 as by fasteners such as the threaded fasteners indicated at 44. Details of this construction are seen in FIG. 4. The chord 32 does not reach all the way to the face plate 40 and this is intended. It facilitates the in-situ erection of the clarifier support unit. The face plate 40 with the chord support 42 for the upper chord 32 is connected to a side wall 18 and a second face plate 40 (shown in FIG. 3) for the lower chord 34 is secured to the same side wall 18. The same face plate and chord connector arrangement is made on the opposed side wall 18 (see FIG. 1).

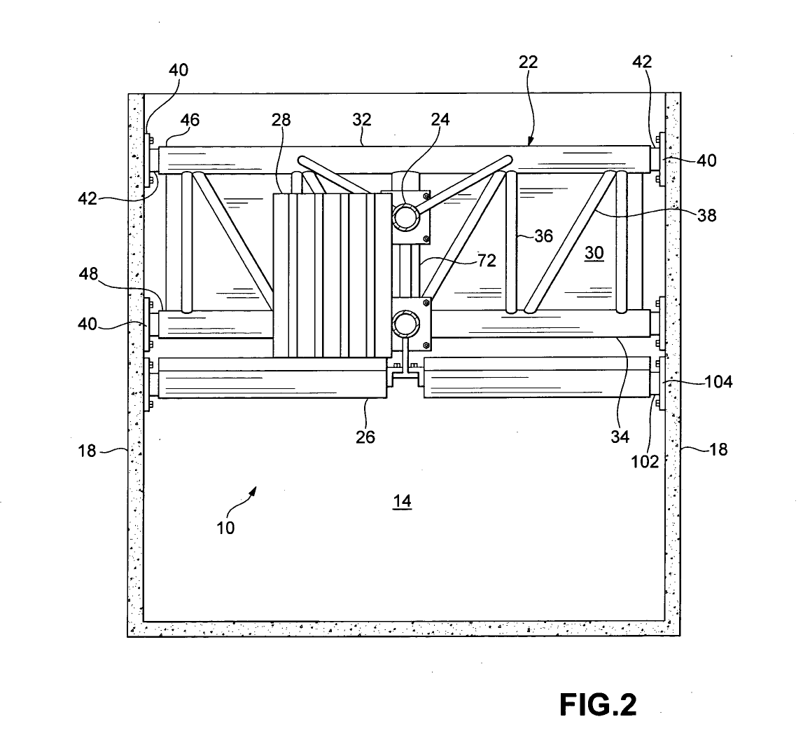

The in-situ erection of the clarifier support can begin with the truss 22 and the step of securing the face plates 40 with chord supports 42 attached thereto at the desired positions on the side walls 18. With the face plates 40 and chord supports 42 in place, the truss 22 is maneuvered into a position in which a first end 46 of the upper chord 32 and a first end 48 of the lower chord 34 are supported by the chord supports 42 (FIG. 2). The ends 46 and 48 of the upper and lower chords 32 and 34 of the truss 22 are then moved towards the face plates 40. The lengths of the truss 22 and the lengths of the chord supports 42 are controlled so that, when the first ends 46 and 48 of the chords 32 and 34 are touching the corresponding face plates 40, the opposed ends of the chords 32 and 34 do not reach the corresponding chord supports on the opposite side wall 18. The lengths of the truss 22 and the lengths of the chord supports 42 may also be controlled so that, when the first ends 46 and 48 of the chords 32 and 34 are touching the corresponding side wall 18, the opposed ends of the chords 32 and 34 do not reach the corresponding chord supports on the opposite side wall The truss 22 is then maneuvered to align the other ends of the chords 32 and 34 with the chord supports 42 supported on face plates 40 on the opposite side wall 18. The truss 22 is moved (from left to right in FIG. 2) towards the face plates 40 of the chord supports 42 on the opposite side wall 18 until both ends of the chords 32 and 34 are supported by portions of all four chord supports 42. The position of the truss 22 relative to the chord supports 42 is then adjusted so that, as nearly as is practical, the ends of the chords 32 and 34 are supported on the four chord supports 42 so that approximately equal lengths of the ends of the chords 32 and 34 are engaged with the four chord supports 42. When the adjustment is completed, the position of the truss 22 is fixed, for example, by threaded fasteners 50, one of which is shown in FIG. 4, which extend through apertures in the chord supports 42 and the ends of the chords of the truss 22. Fasteners 50 may be provided at one or both ends of the chords 32 and 34.

The in-situ erection of the clarifier support can continue with the truss 24. One end of the truss 24 is going to be supported on the rear wall 16 and the other end of the truss 24 is going to be supported directly on the main lateral truss 22. The truss 24 is similar to the truss 22 although, typically, truss 22 will be longer and taller than truss 24. The truss 24 comprises an upper chord 52 and a lower chord 54 and they are connected by vertical struts 56 and diagonal struts 58. The upper and lower chords 52 and 54 have first ends 60 and 62 which will be supported on the rear wall 16 in a manner similar to the manner in which the ends of the lateral truss 22 are supported on the side walls 18. The first ends 60 and 62 of the upper and lower chords 52 and 54 are aligned with chord supports 64 on face plates 66 which have been attached to the rear wall 16 in desired positions. The ends 60 and 62 of the chords 52 and 54 are advanced towards the face plates 66 so that the first end of the truss 24 is supported at the rear wall 16 of the tank 12.

The upper and lower chords 52 and 54 of the truss 24 have second ends 68 and 70, respectively, and they are supported on the lateral truss 22. In the embodiment illustrated in the drawing figures, second end 70 of lower chord 54 of truss 24 is connected to the lower chord 34 of the lateral truss 22 and, as can be seen in FIG. 3, the second end 68 of chord 52 is connected to a major vertical strut 72 in the truss 22. Suitable connections are described below and illustrated in the drawing figures. However, myriad other connections, known to persons skilled in this art, are also suitable.

As shown in FIG. 5, an end plate 74 is welded or otherwise secured to the second end 70 of the lower chord 54 of the longitudinal truss 24. Upper and lower end plate brackets 76 and 78 are welded or otherwise secured to the lower chord 34 of the truss 22. Portions of the end plate 74 are parallel to and can be aligned with corresponding portions of the upper and lower brackets 76 and 78. The longitudinally adjustable connections between the first ends 60 and 62 of the chords 52 and 54, and the chord supports 64, facilitate the alignment of the end plate 74 and the brackets 76 and 78. Threaded fasteners 80 connect the end plate 74 to the brackets 76 and 78. A similar connection between the upper chord 52 of truss 24 and the major vertical strut 72 of truss 22 is made involving an end plate 82 (FIG. 3) on chord 52 which is fastened to an end plate bracket(s) 84 that is secured to the strut 72.

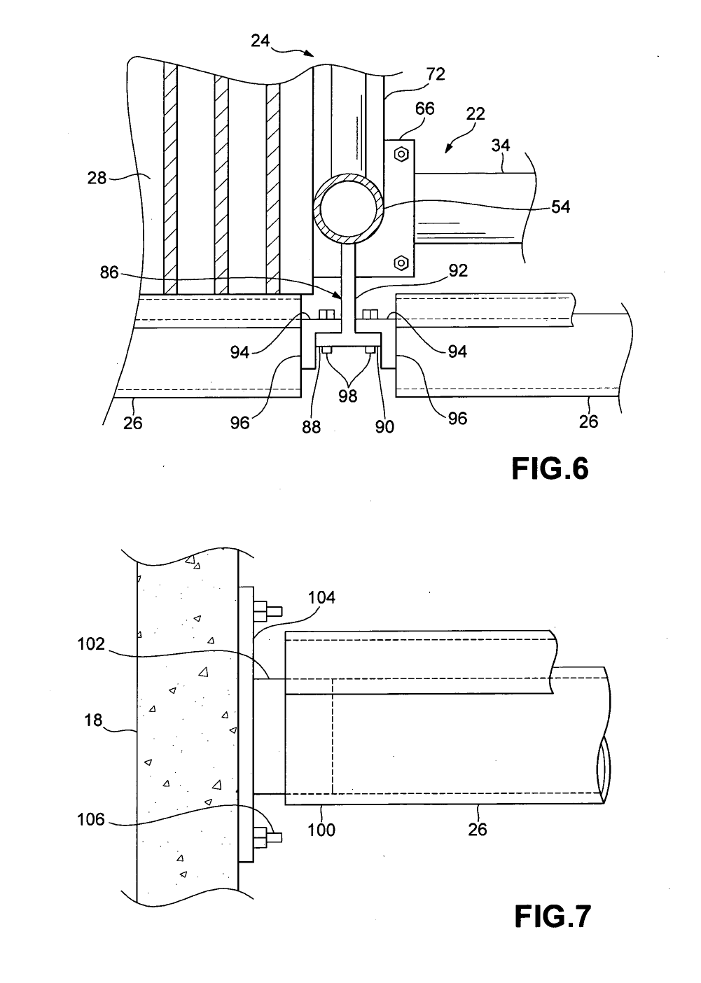

With the trusses 22 and 24 secured to and supported in the tank 12, the erection of the clarifier support structure continues with the module support members 26. In an installation in which there is but one longitudinal truss, one end of each module support member 26 is connected to and supported on a side wall 18 and the other end of each module support member 26 is connected to and supported on the longitudinal truss 24. In an installation in which there is more than one longitudinal truss, both ends of some of the module support members 26 will be connected to and supported by two longitudinal trusses. Suitable connections between module support members 26 and tank side walls 18, as well as connections between module support members 26 and a longitudinal truss 24 are described below with particular reference to FIGS. 6 and 7. Again, myriad other connections, known to persons skilled in this art, are also suitable.

FIG. 6 is a view looking down the lower chord 54 of the longitudinal truss 24 towards the lower chord 34 of the lateral truss 22. A hanger connector 86 is secured, as by welding, to the lower chord 54 of the longitudinal truss 24. The hanger connector 86 is a t-shaped beam with two flanges 88 and 90 which extend outwardly from a central web 92 towards the side walls 18 of the tank 12. A lateral end flange 94 extends outwardly from each of the support members 26. The end flange 94 is part of an L beam and the other flange 96 of the L beam is secured, as by welding or the like, to the end of each of the module support members 26 shown in FIG. 6. When the flange 94 extending from an end of one of the support members 26 rests on one of the two flanges 88 and 90, that end of that support member 26 is supported by the longitudinal truss 24 through the hanger 86. The flange 94 is secured to one of the flanges 88 and 90 as by a threaded connector 98 or the like. The other end of that support member would then be supported either in a similar manner on an adjacent longitudinal truss, if there be such, or at one of the side walls 18 in a manner such as the one illustrated in FIG. 7.

A side wall support for a support member 26 is illustrated in FIG. 7. The member 26 has a wall end 100 which is aligned with a support member support 102 on a face plate 104 which has been attached, as by threaded fasteners 106 to the side wall 18. The wall end 100 of the support member 26 is advanced towards the face plate 104 so that the wall end 100 of the support member 26 is supported at the side wall 18 of the tank. The support member 26 is then manipulated, while the wall end 100 is supported by the support member support 102, until the flange 94 at the opposite end of the support member 26 is supported on the longitudinal truss 24 as by way the hanger connector 86, as shown in FIG. 6, or the like. A threaded connector such as the connector 98 is used to connect the flange 94 to one of the flanges 88 and 90, as shown in FIG. 6. This will fix the longitudinal position of the wall end 100 of the member 26 relative to the member support 102 although it may be desired to further fix the longitudinal position of the support member 26 by connecting the end 100 to the support member support 102, as by a threaded connector (not shown).

It will be apparent to the artisan that the present invention is susceptible of numerous variations from the details described above and illustrated in the various drawing figures. Therefore, notice is hereby given that the invention is not to be limited by the foregoing description but only in light of the spirit and scope of the invention as defined in the claims appended hereto.

I claim:

1. A method for installing a clarifier support structure in a settling tank comprising a bottom, first and second opposed side walls and a rear wall, said method comprising the steps of
providing a major lateral truss having a first end and a second end and installing it in the tank so that its first end is supported on said first side wall and its second end is supported on said second side wall,
providing at least one minor longitudinal truss having a first end and a second end and installing it in the tank so that its first end is supported on said lateral truss and its second end is supported on said rear wall,
providing a first module support member having a first end and a second end and installing it in the tank so that its first end is supported on said first side wall and its second end is supported on said longitudinal truss,
providing a second module support member having a first end and a second end and installing it in the tank so that its first end is supported on said second side wall and its second end is supported on said longitudinal truss.

2. The method claimed in claim 1 wherein said first module support member is closer to said tank floor than is said longitudinal truss.

3. A settling tank and a clarifier support structure supported therein, said tank comprising first and second opposed walls and a wall extending transversely or laterally relative to the opposed walls, said clarifier support structure comprising
a major lateral truss having a first end and a second end, said first end of said lateral truss supported on said first wall and said second end of said lateral truss supported on said second side wall,
at least one minor longitudinal truss having a first end and a second end, said first end of said longitudinal truss supported on said lateral truss and said second end of said longitudinal truss supported on said laterally extending wall,
a first module support member having a first end and a second end, said first end of said module support member supported on said first wall and said second end of said module support member supported on said longitudinal truss,
a second module support member having a first end and a second end, said first end of said second module support member supported on said second wall and said second end of said module support member supported on said longitudinal truss.

4. A method for installing and supporting a member on and between first and second opposed walls at points where the distance between said first and second walls is equal to X, said member having
a length equal to Y,
a first end, and
a second end,
said method comprising the steps of
providing a first support element comprising a member support having a first end and a second end and a face plate secured to said first end of said member support,
securing said face plate of said first support element to said first wall so that said member support extends from said face plate towards said second wall and so that the distance between said first wall and said second end of said member support is equal to A,
providing a second support element comprising a member support having a first end and a second end and a face plate secured to said first end of said member support,
securing said face plate of said second support element to said second wall so that said member support extends from said face plate towards said first wall and so that the distance between said second wall and said second end of said member support is equal to B,
controlling the value of the length Y and the value of the length A so that Y is less than or equal to X minus A or so that Y is less than or equal to X minus A,
engaging said first end of said member on said first support element so that said first end of said member is slidably supported thereon,
advancing said member towards said first wall,
aligning said second end of said member with said second support element, and
advancing said member towards said second wall until said first and second ends of said member are supported on said first and second support elements, respectively.

5. The method claimed in claim 4 which further comprises the step of locking the member to at least one of said first and second support elements to prevent relative longitudinal movement therebetween.
